(19) United States
(12) Patent Application Publication
(10) Pub. No.: US 2011/0208379 A1
(43) Pub. Date: Aug. 25, 2011

(54) HYBRID DRIVE SYSTEM

(76) Inventor: Stephan Otto, Weissach (DE)

(21) Appl. No.: 12/737,648

(22) PCT Filed: Aug. 12, 2009
(86) PCT No.: PCT/EP2009/060417

§ 371 Date: May 9, 2011

(30) Foreign Application Priority Data
Aug. 19, 2008 (DE) 102008041351.8

(51) Int. Cl. B60W 20/00; B60W 10/06; B60W 10/08

(52) U.S. Cl. 701/22; 903/930; 180/65.265

(57) ABSTRACT

A hybrid drive system (2, 19) for a motor vehicle (1, 18) has an electric motor (3) and an internal combustion engine (6). The electric motor (3) and the internal combustion engine (6) are at least temporarily coupled (7, 10, 11) to each other at a fixed speed ratio. The speed of the hybrid drive system (2, 19) is sensed by a speed sensing device (12). The data obtained in said manner are used for at least partially controlling the electric motor (3) and the internal combustion engine (6).

### BACKGROUND OF THE INVENTION

1. Field of the Invention

The present invention relates to a hybrid drive system for a motor vehicle having at least one control system, at least one rotational speed detecting device, at least one electric machine and at least one internal combustion engine, and in which at least one electric machine and at least one internal combustion engine are linked together at least temporarily at a fixed rotational speed ratio. The present invention also relates to a method for operating at least one electric machine and at least one internal combustion engine, in which at least one of the electric machines and at least one of the internal combustion engines is designed and equipped in such a way that they are operated at least temporarily at a fixed rotational speed ratio to one another.

2. Description of Related Art

Against the background of rising crude oil prices and the developing changes in the earth's climate, there is an ever-growing demand for the most fuel-efficient vehicles having the lowest possible consumption.

A promising approach for such fuel-efficient and low-consumption motor vehicles lies in the use of hybrid drive systems. In hybrid drive systems, in addition to the normal internal combustion engine, another motor is used, which utilizes a different form of energy to drive the motor vehicle. Electric machines have proven successful for this purpose in practice.

Through the use of additional motors, it is possible on the one hand to operate the internal combustion engine largely permanently in a particularly energy-efficient operating mode. The drive energy which is supplied by the internal combustion engine and is not used to drive the motor vehicle at a certain point in time may be stored temporarily in an energy storage mechanism such as a battery. At a later time, the energy stored temporarily in this way may be utilized to drive the motor vehicle. In addition, it is also possible to convert the kinetic energy of the motor vehicle when the vehicle accelerates into electric energy and to store it temporarily in the battery. The braking energy is then not lost.

On the basis of these (and additional) effects, motor vehicles using hybrid drive systems are particularly fuel-efficient, in particular when the vehicle is operated in stop-and-go traffic or in city traffic.

Because this technology is still relatively new, there are still a great many as yet unsolved partial problems, which have so far prevented a rapid spread of hybrid drive systems.

One major problem is still the cost of hybrid drive systems. In addition to the internal combustion engine, an electric machine must be provided, so this increases the cost accordingly. Additional costs arise due to the fact that both the internal combustion engine and the electric machine must be provided with additional sensors and additional control devices, which must also be sufficiently accurate.

The hybrid drive systems known in the related art have corresponding disadvantages.

### SUMMARY OF THE INVENTION

It is therefore proposed that a hybrid drive system for a motor vehicle having at least one control system, at least one rotational speed detecting device, at least one electric machine, and at least one internal combustion engine, such that at least one electric machine and at least one internal combustion engine are linked together at least temporarily at a fixed rotational speed ratio, be designed in such a way that the control system uses at least temporarily the data of a first rotational speed detecting device for at least partial control of at least one electric machine and at least one internal combustion engine. The at least temporarily simultaneous detection of the rotational speed of the at least one electric machine and the rotational speed of the at least one internal combustion engine via a first rotational speed detecting device and its use for at least partial control of at least one electric machine as well as at least one internal combustion engine is performed in particular at those points in time (or time segments) during which the at least one electric machine and the at least one internal combustion engine are linked together at a fixed rotational speed ratio. At points in time when the electric machine and the internal combustion engine are linked together, using and, if necessary, also providing a first (shared) rotational speed detecting device is often completely adequate and, if necessary, an additional rotational speed detecting device or the use of data obtained thereby may be completely omitted. It should be pointed out here that a (more detailed) knowledge of the rotational speed of the electric machine and/or the internal combustion engine is usually necessary in particular when the motor vehicle is in an active driving mode, for example, in an acceleration mode, a driving mode or a recuperation mode. In such operating modes of the motor vehicle, however, the electric machine and the internal combustion machine are often linked together anyway. In the other operating modes, in which there is no coupling between the electric machine and the internal combustion engine at a fixed rotational speed ratio to one another, the (particular) rotational speed for both motors (i.e., the electric machine and the internal combustion engine) may not be detected by the individual (shared) rotational speed detecting device, but the rotational speed may be roughly estimated (for example, based on the electric power of an electric machine or the electric power of an injection pump for an internal combustion engine) based on other parameters—if this is deemed necessary—or an additional independent rotational speed detecting device may be provided in another area of the hybrid drive system. The additional independent rotational speed detecting device may as a rule have a simpler design than the shared rotational speed detecting device, so that the overall configuration may nevertheless be less expensive. The data obtained thereby may then be used to control the hybrid drive system (or parts thereof, such as to control the internal combustion engine in particular) only if the internal combustion engine and the electric machine are operated “independently of one another” (i.e., not at a fixed rotational speed ratio to one another). However, it is also fundamentally possible that the data obtained by the additional rotational speed detecting device may be used to fulfill certain control information. Only different types of control functions for which more accurate data are required, for example, are then implemented by using data obtained from the first rotational speed detecting device (if the internal combustion engine and the electric machine are operated at a fixed rotational speed ratio to one another). It is also fully sufficient that the internal combustion engine and the electric machine are linked together at a fixed known rotational speed ratio (for example, via a planetary gear). The rotational speed of the internal combustion engine may then be determined by multiplying the rotational speed of the electric machine by the appropriate factor. It is of course also possible for the fixed rotational speed ratio to be different in various operating modes of the hybrid drive system, whereas the actual operating mode is constant. In other words, it is also possible for the rotational speed ratio of the electric machine and the internal combustion engine to be “switched.” The term “electric machine” is understood in particular to refer to electric motors, electric generators and electric machines, which are operated as electric motors some of the time and as generators some of the time. Basically any rotational speed detecting devices known in the related art, such as rotational speed detecting devices, which provide information about the rotational speed of a certain device with the aid of a sensor wheel by electric, electromagnetic, magnetic or optical methods, may be used as the rotational speed detecting device. Using suitably designed rotational speed detecting devices, an essentially constant measurement of the rotational speed (e.g., even after rotation by a few angle degrees or fractions thereof) is also possible. An angular speed determination of the particular component is usually possible with no problem when using suitable rotational speed detecting devices.

It may prove suitable in particular if at least one of the electric machines and at least one of the internal combustion engines are linked together essentially permanently at a fixed rotational speed ratio. In this case it is possible to completely omit an additional independent rotational speed detecting device, if necessary, or it is possible to design an additional independent rotational speed detecting device, which is still necessary, to be even simpler. A particularly simple and inexpensive design of the hybrid drive system may be achieved in this way. In particular when the time intervals during which there is no coupling of the internal combustion engine and the electric machine at a fixed rotational speed ratio are very short, it is usually possible to completely omit an additional independent rotational speed detecting device because the internal combustion engine and/or the electric machine continue to run on the basis of “mass inertia” anyway during these short time intervals, for example.

It is also possible that at least one first rotational speed detecting device is connected to, preferably integrated into, at least one electric machine because a relatively accurate knowledge of the rotational speed of an electric machine is often necessary for operation thereof, which is why corresponding rotational speed detecting devices are often provided anyway with commercial electric machines, and these rotational speed detecting devices usually already supply relatively accurate measured values. It is also frequently possible to some extent, based on the electric input signals or output signals of the electric machine, to make a very accurate statement about their rotational speed, which is in most cases also possible without having to provide additional rotational speed detecting sensors. Therefore, it is possible to further reduce the cost of the hybrid drive system in most cases.

It may also prove advisable if at least parts of a control system of the hybrid drive system are developed in conjunction with at least one electric machine, in particular together with the control unit of at least one electric machine. For triggering electric machines, it is usually necessary anyway to provide electric or electronic control units (for example, a single-board computer). Such electric or electronic control units of electric machines usually have systems and/or algorithms even in commercial electric machines, which take into account the rotational speed of the electric machine for the triggering thereof. These systems and/or algorithms may usually be adapted easily, so that they also assume at least temporarily and/or at least partially the triggering of at least one internal combustion engine. To this extent, the control system of the hybrid drive system may in this case rely on systems already in existence anyway, so that it is possible in this way to save on additional costs in a particularly elegant manner. In particular it is then usually possible to avoid a “double design” of corresponding systems.

It may prove particularly advisable if at least one first rotational speed detecting device and/or at least parts of the control device of the hybrid drive system are designed as a high-frequency data acquisition device. By using such rapid and frequent data acquisition, the quality of the rotational speed signal may be increased significantly. In particular a high-frequency data acquisition device is understood to be a data acquisition device having a particularly high data sampling rate. In particular it may thereby be possible to take into account the rotational speed signal thereby detected for calculation of additional parameters. Through the proposed high data rate or data accuracy, it may thus be possible to ascertain the corresponding parameters at a particularly advantageous signal-to-noise ratio. The sampling may take place in a 100 μs time grid, for example. The rotational speed measuring signal thereby detected is thus advantageously not updated only after a complete revolution of the corresponding device but instead preferably more often, for example, after only a fraction of a revolution of the corresponding device. As already mentioned, the resolution of the rotational speed detecting devices and/or the control device of electric machines is/are often in this range anyway or at least is in a range approaching the aforementioned range, for example.

It is possible, for example, that at least parts of the control system are designed as a rotational speed perturbation detecting device and/or as a combustion error detection device, in particular for at least one internal combustion engine. Using the rotational speed signals which are usually available with high quality from the first (shared) rotational speed detecting device, it is possible in a particularly advantageous manner to determine further parameters which may be ascertained on the basis of the rotational speed detected. The further parameters thereby ascertained, such as information about a rotational speed perturbation of the internal combustion engine or information about combustion errors in the internal combustion engine, may then be supplied to corresponding control systems for reregulating the internal combustion engine or the electric machine. In particular in the case of an accurate and frequently updated rotational speed measured value, the corresponding parameters may usually be ascertained with a high quality and with a very good signal-to-noise ratio. A combustion error measured value is to be understood in particular as a signal which provides information about the presence, the quality (properties) or the frequency of misfiring and/or a statement about the thoroughness of combustion of the internal combustion engine. This readily allows detection of misfiring in a hybrid vehicle in a particularly simple manner. The ignition failure detection may be based on detection of a rotational speed perturbation due to the absence of torque contributions by the internal combustion engine in particular.

Another appropriate specific embodiment may be obtained when at least one additional rotational speed detecting device is provided in the hybrid system, preferably one that is designed in conjunction with at least one internal combustion engine. This additional rotational speed detecting device may also be used in particular to obtain data about the operating mode of parts of the hybrid drive system (in particular of the internal combustion engine) when the electric machine and internal combustion engine are not operated at a fixed rotational speed ratio to one another. Another possible use for such an additional rotational speed detecting device is for it to supply data not measurable by the first (shared) rotational speed detecting device or measurable only with a high error. To this end, it is possible to optimize at least one additional rotational speed detecting device for acquisition of certain data in a targeted manner.

In addition, it is proposed that a method for operating at least one electric machine and at least one internal combustion engine in which at least one of the electric machines and at least one of the internal combustion engines is designed and equipped in such a way that they are operated at a fixed rotational speed ratio to one another at least some of the time, be performed in such a way that data are acquired by at least one first rotational speed detecting device at least during operation at a fixed rotational speed ratio to one another, these data being used at least occasionally for at least partial control of at least one of the internal combustion engines and at least one of the electric machines. Such a method has the properties and advantages already described in conjunction with the proposed hybrid drive system in a similar manner. In particular it is possible to further refine the method similarly in the sense of the proposals made in conjunction with the proposed hybrid drive system. Such a further refined method also has the aforementioned properties and advantages in a similar manner.

It is possible in particular to design and equip at least one of the electric machines and at least one of the internal combustion engines in such a way that they are equipped at least partially as part of the hybrid drive system, in particular as part of a hybrid drive system for a motor vehicle. The motor vehicle may be an aircraft, an aquatic vessel or a farm vehicle (rail-bound or not rail-bound). The method proposed above is suitable to a particular extent for the purpose proposed here.

In addition, it is possible to perform the method in such a way that at least one of the electric machines and at least one of the internal combustion engines are designed and equipped in such a way that they are operated at least essentially permanently at a fixed rotational speed ratio to one another. The method proposed in the present case is also particularly advantageous for this application.

It may be advantageous in particular if rotational speed detection is performed at a high sampling rate. In particular the rotational speed detection should be performed more often than just once per revolution of the corresponding device. Instead, it is advisable for the rotational speed detection to be performed each time a relatively small rotational angle of, for example, 1°, 2°, 3°, 4° or 5° (or even fractions of a degree) is passed. Alternatively or additionally, it is possible for the rotational speed detection to be performed at a time rate of 300 μs, 250 μs, 200 μs, 150 μs, 100 μs, 75 μs, 50 μs or 25 μs, for example. This may yield particularly accurate information with regard to the rotational speed of the device(s). It is possible in particular to use the rotational speed information thereby obtained for further purposes, for example, for calculation of additional parameters.

It is thus possible to use the rotational speed detection for detection of perturbations in rotational speed and/or for detection of defective ignition processes, in particular in the internal combustion engine.

It may also prove advantageous if data of at least one additional rotational speed detecting device are used to control at least one electric machine and/or at least one internal combustion engine.

### BRIEF DESCRIPTION OF THE DRAWIANGS

The present invention is explained in greater detail below with reference to the accompanying figures and with the use of exemplary embodiments.

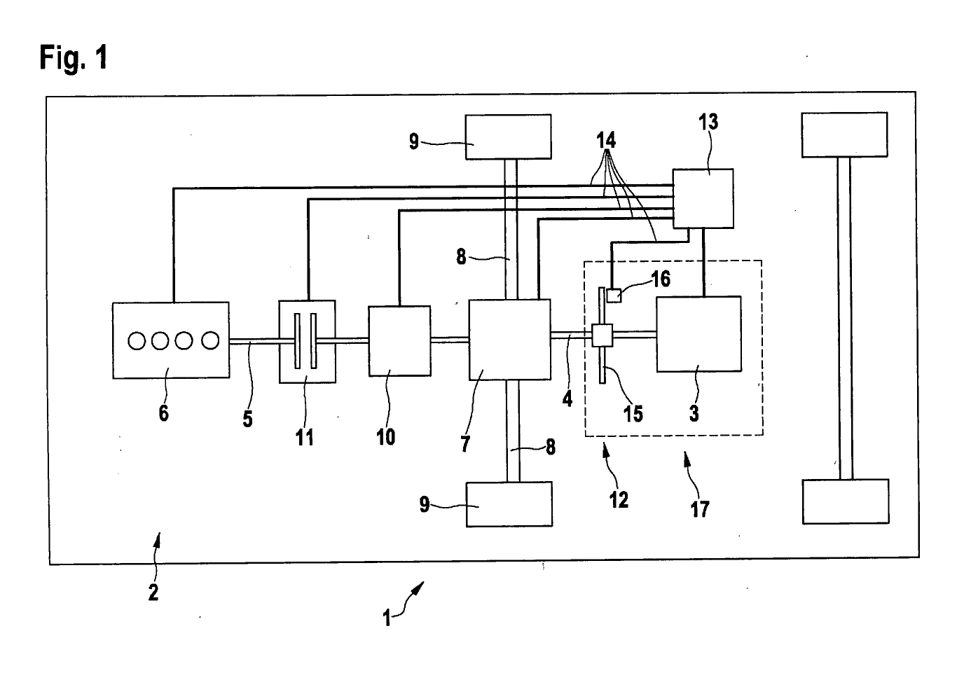

FIG. 1 shows a schematic view of a hybrid vehicle according to a first exemplary embodiment.

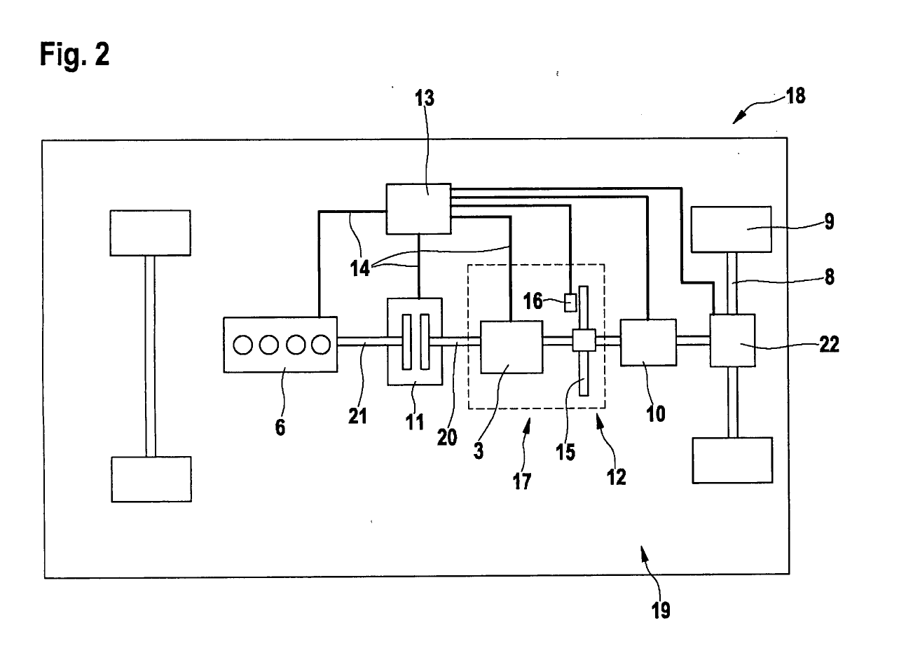

FIG. 2 shows a schematic view of a hybrid vehicle according to a second exemplary embodiment.

FIG. 3 shows a schematic view of a hybrid vehicle according to a third exemplary embodiment.

FIG. 4 shows a schematic view of a hybrid vehicle according to a fourth exemplary embodiment.

### DETAILED DESCRIPTION OF THE INVENTION

FIG. 1 shows a motor vehicle 1 having a hybrid drive 2 as the drive. Motor vehicle 1 and hybrid drive 2 are shown only schematically to illustrate the principle.

Hybrid drive 2 includes an electric machine 3 having a first drive shaft 4 and an internal combustion engine 6 having a second drive shaft 5. First drive shaft 4 is connected directly to electric machine 3, while second drive shaft 5 is connected directly to internal combustion engine 6. Both drive shafts 4, 5 are interlinked via a planetary gear 7. The shared drive power of internal combustion engine 6 and electric machine 3 (which may of course also be negative, for example, when the motor vehicle is in a recuperation mode) is supplied via planetary gear 7 to drive axle 8 on which wheels 9 are mounted. This design of a hybrid drive 2 is also known as so-called torque coupling. First drive shaft 4 and second drive shaft 5 are thus interlinked via planetary gear 7 at a fixed rotational speed ratio, which is predefined by the design of planetary gear 7.

In addition, in the exemplary embodiment shown here of hybrid drive 2, a transmission 10 and a clutch 11 are provided between internal combustion engine 6 and planetary gear 7 for second drive shaft 5. This makes it possible to always operate internal combustion 6 at different driving speeds of motor vehicle 1 in a largely fuel-efficient rotational speed range and/or torque range. Internal combustion engine 6 may additionally be disengaged via clutch 11, for example, to shift transmission 10 or to operate vehicle 1 in a mode in which vehicle 1 is moved or decelerated exclusively with the aid of electric machine 3. In the latter case, energy which would have to be applied to overcome the mechanical resistance of internal combustion engine 6 may be saved.

The embodiment of hybrid drive 2 shown in FIG. 1 allows the use of a single speed measuring device 12 both for internal combustion engine 6 and for electric machine 3. If clutch 11 is engaged, the rotational speed of internal combustion engine 6 may be determined directly and unambiguously when the instantaneous transmission ratio of transmission 10, the transmission performance of planetary gear 7, as well as the rotational speed of electric machine 3 are known. An exact knowledge of the rotational speed of internal combustion engine 6 is necessary only in an operating mode in which internal combustion engine 6 is used at least in part to drive motor vehicle 1. In such a case, however, clutch 11 is engaged anyway.

However, if clutch 11 is disengaged, no (direct) information about the rotational speed of internal combustion engine 6 may be obtained with the aid of speed measuring device 12. However, an approximate value of the rotational speed based on a trigger signal of internal combustion engine 6 (for example, for an electric injection pump of internal combustion engine 6), which is supplied by an electronic controller 13 to internal combustion engine 6 via an electric line 14, may be ascertained. The estimate of the rotational speed, which is obtainable in this way, is usually accurate enough for practical purposes, because when clutch 11 is disengaged, internal combustion engine 6 need only overcome the internal friction of internal combustion engine 6 (which may be ascertained relatively accurately, e.g., by test bench measurements).

Electronic control device 13 is also connected not only to internal combustion engine 6 but also to clutch 11, transmission 10, speed measuring device 12, electric machine 3 and additional devices, if necessary. The connection via electric lines 14, as shown in FIG. 1, may be in any direction or in both directions. An electric line 14 may thus mean that a measuring signal is detected over this electric line 14, a control signal is output, or both.

In the exemplary embodiment of hybrid drive 2 shown in FIG. 1, speed measuring device 12 includes a sensor wheel 15, which is attached to first drive shaft 4 in a rotationally fixed manner, as well as a measuring sensor 16, which is adjacent to a radially outer area of sensor wheel 15. In the exemplary embodiment shown in FIG. 1, sensor wheel 15, measuring sensor 16 and electric machine 3 are combined into one structural unit 17. The rotational speed may be detected by speed measuring device 12 in any way, by a mechanical method, by an optical method, by an electrical method, by a magnetic method and/or by an electromagnetic method. Purely as an example, a shunt resistor, a sense MOSFET and/or a Hall sensor may be used.

Moreover, it is also possible, additionally or as an alternative to speed measuring device 12 shown in FIG. 1, for the rotational speed to be detected with the aid of the internal design of electric machine 3. The rotational speed detection may thus be based on the electric current flowing in one or more stator windings of the electric machine. Likewise, the rotational speed detection may be based on the electric current flowing in the governor winding of electric machine 3 to ascertain, for example, the voltage component, which is obtained by induction of the stator windings back into the governor winding. The signals obtained in this way may also be combined with the signals of speed measuring device 12 (or some other type of speed measuring device), which may be present, to increase the accuracy of the rotational speed measured values. This combination may take place in electronic control device 13, for example.

FIG. 3 shows a modification of hybrid drive 1 shown in FIG. 1. In the present hybrid drive 23, an additional sensor wheel 25 is mounted on drive shaft 5 of internal combustion engine 6. Additional measuring sensor 24 ascertains with the aid of additional sensor wheel 25 the rotational speed of internal combustion engine 6 independently of whether clutch 11 is engaged or disengaged.

The data obtained with the aid of additional measuring sensor 24 are used by electronic control device 13 to trigger internal combustion engine 6. For example, the data obtained by additional measuring sensor 24 are used to ascertain the shift strategy of transmission 10, in order to control the fuel supply to internal combustion engine 6. Additional measuring sensor 24 and additional sensor wheel 25 are optimized for supplying the required data with high quality. Similarly, the data ascertained by measuring sensor 16 are used to trigger electric machine 3.

However, the data obtained by measuring sensor 16 are additionally used by electronic control device 13 to detect misfiring or other combustion errors by internal combustion engine 6, to initiate appropriate correction measures, if necessary. The data obtained by measuring sensor 16 are particularly suitable for this purpose because a sensor wheel 15 and a measuring sensor 16, which have a high precision and a high measured value sampling frequency, must generally be used anyway with commercial electric machines 3. A high precision as well as a high measured value sampling frequency both improve the accuracy of detection of misfiring and/or other combustion errors in internal combustion engine 6.

FIG. 2 shows a second exemplary embodiment of a motor vehicle 18 equipped with a hybrid drive 19, which differs in many regards from hybrid drive 2 shown in FIG. 1. For reasons of simplicity, the same reference numerals are used for components of the same type as in FIG. 1.

Similarly to motor vehicle 1 shown in FIG. 1, the present motor vehicle is also equipped with an internal combustion engine 6 and an electric machine 3, both of which supply their drive power to a shared drive axle 8. Internal combustion engine 6 drives a drive shaft 21, which may be connected by a clutch 11 to a shared drive shaft 20 in a rotationally fixed manner or may be mechanically separated from it. Electric machine 3 is mounted on shared drive shaft 20. Shared drive shaft 20 may be embodied here as a continuous shaft, which passes through electric machine 3. Shared drive shaft 20 leads to a transmission 10, using which the rotational speed ratio between shared drive shaft 20 and drive axle 8 may be adjusted suitably. The driving power is transmitted from transmission 10 via a differential gear 22 to drive axle 8 and thus ultimately to wheels 9.

In addition, a speed measuring device 12 having a sensor wheel 15 and a measuring sensor 16 is mounted on shared drive shaft 20. Here again, sensor wheel 15, measuring sensor 16 and electric machine 3 may also be embodied as one component 17.

Due to the fact that internal combustion engine 6 is mechanically linked to shared drive shaft 20 (and thus to sensor wheel 15) only via clutch 11, measuring sensor 16 is able to acquire particularly accurate measured data about the rotational speed performance of internal combustion engine 6. In particular no disturbance may occur due to a mechanical play of intermeshing gearwheels. Such a mechanical play is usually unavoidable with a transmission 10. If transmission 10 is an automatic transmission, then there is also slippage between the input shaft and the output shaft of the automatic transmission in the usual designs. However, based on the design of hybrid drive 19 shown in FIG. 2, this is also suitable for automatic transmissions.

FIG. 4 shows a modification of hybrid drive 19 shown in FIG. 3. The hybrid drive system 26 shown in the present case has an additional sensor wheel 25 and an additional measuring sensor 24 on the drive shaft 21 of internal combustion engine 6 similarly to hybrid drive system 23 shown in FIG. 3.

Here again, similarly to hybrid drive 23 shown in FIG. 3, the data obtained by measuring sensor 16 are used by electronic control device 13 for triggering electric machine 3 and additionally for detecting misfiring and/or other combustion errors of internal combustion engine 6. However, the other control tasks of internal combustion engine 6 are taken over by the electronic control device using data obtained by additional measuring sensor 24.

1-13. (canceled)

14. A hybrid drive system for a motor vehicle, comprising: at least one control system; at least one rotational speed detecting device; at least one electric machine; and at least one internal combustion engine; wherein at least one electric machine and at least one internal combustion engine are linked together at least temporarily at a fixed rotational speed ratio, and wherein the control system uses data of a first rotational speed detecting device for at least partial control of at least one electric machine and at least one internal combustion engine at least temporarily.

15. The hybrid drive system as recited in claim 14, wherein at least one of the electric machines and at least one of the internal combustion engines are coupled together at least essentially permanently at a fixed rotational speed ratio.

16. The hybrid drive system as recited in claim 14, wherein at least one first rotational speed detecting device connected to at least one electric machine is integrated into at least one electric machine.

17. The hybrid drive system as recited in claim 14, wherein at least parts of a control system of the hybrid drive system are developed in conjunction with the control unit of at least one electric machine.

18. The hybrid drive system as recited in claim 14, wherein at least one first rotational speed detecting device or at least parts of the control device are designed as a high-frequency data acquisition device.

19. The hybrid drive system as recited in claim 14, herein at least parts of the control system are designed as a rotational speed perturbation detecting device or as a combustion error detection device.

20. The hybrid drive system as recited in claim 14, further comprising at least one additional rotational speed detecting device.

21. The hybrid drive system as recited in claim 20, wherein the at least one additional speed detecting device is connected to at least one internal combustion engine.

22. A method for operating at least one electric machine and at least one internal combustion engine, comprising: operating at least one electric machine and at least one internal combustion engines at least temporarily at a fixed rotational speed ratio to one another, wherein data which are used at least temporarily for at least partial control of at least one of the internal combustion engines and at least one of the electric machines are acquired by at least one first rotational speed detecting device at least during operation at a fixed rotational speed ratio to one another.

23. The method as recited in claim 22, wherein at least one of the electric machines and at least one of the internal combustion engines are designed and equipped in such a way that they are equipped at least temporarily as part of a hybrid drive system for a motor vehicle.

24. The method as recited in claim 22, wherein at least one of the electric machines and at least one of the internal combustion engines are designed and equipped in such a way that they are operated at least essentially permanently at a fixed rotational speed ratio to one another.

25. The method as recited in claim 22, wherein data of the rotational speed detecting device are acquired at a high sampling rate.

26. The method as recited in claim 22, wherein data of the rotational speed detecting device are used for recognizing a perturbation in rotational speed or for detecting defective ignition processes.

27. The method as recited in claim 22, wherein data of at least one additional rotational speed detecting device are used to control at least one electric machine or at least one internal combustion engine.
